(19) United States
(12) Patent Application Publication
(10) Pub. No.: US 2016/0169288 A1
(43) Pub. Date: Jun. 16, 2016

(54) ROLLING-ELEMENT BEARING FOR A GEARING

(71) Applicants: ZF FRIEDRICHSHAFEN AG, Friedrichshafen (DE); ZF WIND POWER ANTWERPEN N.V., Kontich (BE)

(72) Inventors: Dirk LEIMANN, Edegem (BE); Kurt ENGELEN, Mol (BE)

(21) Appl. No.: 14/907,395

(22) PCT Filed: Jun. 30, 2014
(86) PCT No.: PCT/EP2014/063792

§ 371 Date: Jan. 25, 2016

(30) Foreign Application Priority Data
Jul. 29, 2013 (DE) 10 2013 214 703.1

(51) Int. Cl. F16C 41/00; G01P 3/44; F16C 33/34

(52) U.S. Cl. CPC F16C 41/007; F16C 33/34; G01P 3/443

(57) ABSTRACT

A rolling-element bearing for a gearing. The rolling-element bearing includes an inner bearing race (13), an outer bearing race (14), and at least one rolling element (15). The rolling-element bearing has a sensor (19) which is rigidly arranged in relation to a gearing part or a part of the rolling-element bearing. The rolling element includes a depth deviation (16), on at least one lateral surface (17), and the depth deviation is designed in such a way that the lateral surface of the rolling element has at least two different depths along a circular path about an axis of rotation of the rolling element and the sensor is positioned in order to detect the depth deviation.

This application is a National Stage completion of PCT/EP2014/063792 filed Jun. 30, 2014, which claims priority from German patent application serial no. 10 2013 214 703.1 filed Jul. 29, 2013.

### FIELD OF THE INVENTION

The present invention relates to a roller element for a gearing and to a method for determining the speed, the rotational speed and/or the slip of at least one rolling element.

### BACKGROUND OF THE INVENTION

Roller bearings are used in particular to mount shafts so that they can rotate, and often comprise an inner race, an outer race and a rolling element. The inner race is arranged inside the outer race and the rolling element between the inner race and the outer race. The rolling elements roll against the inner race and the outer race.

Since bearings, such as roller bearings, are important components of transmissions, for example transmissions for a wind power machine, and bearing damage can result in total failure of the transmission, it is necessary to be able to analyze bearing damage accurately. An important part of the analysis of bearing damage is the measurement of slip for the determination of slip phenomena in the bearing. In what follows, “slip” is understood to mean a sliding movement of the rolling elements relative to the inner and/or the outer bearing races. In general, three types of slip are important here, namely cage slip, rolling element slip and axial slip.

FIG. 1 illustrates the three types of slip. For this, FIG. 1 shows a bearing 1 with an inner race 2, an outer race 3 and rolling elements 4 between the inner race 2 and the outer race 3.

Rolling element slip 5 means slip movement of a rolling element 4 in the circumferential direction of the inner race or the outer race.

Such slipping movement of the rolling element 4 can be combined with sliding movements in other directions or with rotational movements.

Axial slip 6 is understood to mean movement of a rolling element 4 in which the rolling element 4 moves along its rotational axis.

Cage slip 7 is slipping of the inner and/or outer races over the rolling elements.

Methods for determining the rolling element slip are already known. DE 102008 061 280 describes a method for determining the rotational speed of a rolling element by measuring the magnetic field of one or more magnetized rolling elements. Optical methods are also used, for example the use of a high-speed camera, mostly in combination with an image de-rotation prism for determining the rotational speed of the rolling element.

However, the above-described methods are only suitable to a limited extent or even not at all for application in wind power machines. When optical methods are used any lubrication oils or greases present, which are needed for the lubrication of rotating parts, can interfere with the visibility of the rolling elements. Furthermore it is often disadvantageous to fit a camera into a wind power transmission, if only because of the space it takes up.

When magnetized rolling elements are used there is a risk that they may attract metal particles, which result in premature bearing damage. Moreover, the results obtained by magnetic methods are often unreliable because wind power transmissions are made in part from magnetic materials, which interfere with the magnetic field measurements. In addition, the measurements are often disturbed by electric stray currents present in wind power transmissions.

### SUMMARY OF THE INVENTION

An objective of the invention is to provide a device and/or a method suitable for determining the slip of at least part of a roller bearing.

This objective is achieved by a roller bearing and a method as described below.

In particular, the objective can be achieved by a roller bearing for a transmission, especially a transmission for a wind power machine. The roller bearing can comprise an inner bearing race, an outer bearing race and at least one rolling element.

The roller bearing comprises a sensor arranged in a fixed position relative to a transmission component or a part of the roller bearing. At least on one lateral surface, the rolling element has a depth variation. In this case the depth variation is designed such that the lateral surface of the rolling element has at least two different depths along a circular path around a rotational axis of the rolling element. The sensor is positioned in such manner that it can detect the depth variation.

Thus, it has been recognized that a speed, position or slip measurement can be made by virtue of the depth variations on the rolling elements and a sensor that detects these depth variations. This measurement does not require the use of sensitive optical methods or of a magnetic field, and therefore provides a reliable result.

The inner bearing race or outer bearing race does not have to be in the form of an independent component, but rather, inner or outer bearing races are known which are integrated in or form part of some other component. For example the inner race can be formed as part of the shaft to be mounted and able to rotate in the bearing. The outer bearing race can be a housing component or part of a gearwheel, such as a planetary gearwheel.

The sensor can be arranged fixed relative to a transmission component and/or fixed relative to a bearing component. This facilitates the calculation of the slip from the sensor signals, particularly when the relative movement of the transmission component or bearing component in relation to the inner bearing race and/or the outer bearing race is known. Furthermore, if the sensor is arranged fixed relative to a transmission component and/or a bearing component, the transmission or bearing can be made and fitted as a finished component.

In particular, the sensor can be attached in such manner that it detects the depth variation as a function of the rotational axis of the rolling element and as a function of the angular position of the rolling element.

Thus, a sensor can be arranged so that it only recognizes the depth variation if the latter is at a particular position. In that way, by virtue of a repeated recognition of the depth variation on the circulating rolling element the slip of the rolling element can be determined. Furthermore the sensor, or a number of sensors, can be arranged so that the depth variations at various positions are recognized. This makes it possible to keep track of the movement path of the depth variation at least in sections, and thus to determine the speed, position, acceleration and/or the slip of the rolling element.

In what follows, a depth variation is understood to mean the deviation of the surface of the rolling element relative to a plane perpendicular to the rotational axis of the rolling element, the plane containing at least one point on the surface of the rolling element. If the rolling element has a depth variation, this means that not all of the lateral surface of the rolling element lies in a single plane perpendicular to the rotational axis of the rolling element.

A lateral surface of the rolling element is understood in particular to mean a side that does not come in contact with the inner and/or the outer bearing races. It can also be understood to mean one or more sides of the rolling element that is/are perpendicular to the rolling surface of the rolling element. The rolling surface is understood to mean that surface of the rolling element on which the rolling element rolls at least mainly on the inner or outer race. The arrangement of the depth variation on the lateral surface of the rolling element prevents the depth variation from coming into contact with the working surface of the inner and/or outer race and so affecting the running properties of the rolling element. The arrangement of the depth variation on the lateral surface of the rolling element also makes it possible to position the corresponding sensor only laterally, so that a detection of the depth variation through the inner and/or outer race can be carried out.

Preferably, at least one rolling element, in particular a number of rolling elements and particularly preferably all the rolling elements of the roller bearing have depth variations. In this way, for example, the slip of several rolling elements can be analyzed whereby the investigation methods are rendered more accurate and comprehensive.

Preferably, the at least one rolling element has more than one depth variation. Preferably, the depth variations are arranged a uniform distance apart on a circle around the rotational axis of the rolling element. However, rolling elements are also possible in which the depth variations are a variety of distances apart. In that way the orientation of the rolling element can be coded with reference to the distance between the depth variations.

In a preferred embodiment, the depth variations in all the rolling elements that have such depth variations are positioned at the same places. Thus, the rolling elements with depth variations do not differ from one another by the positions of the depth variations. Accordingly, the signal picked up by the sensor does not depend on the particular rolling element. This facilitates the evaluation of the sensor signals and therefore also the analysis of the slip.

However, it is also possible for different rolling elements to have different types of depth variations. Thus, the position of the depth variations or the difference in height between the lateral surface and the depth variation between the depth variations in a rolling element or between the depth variations of different rolling elements can vary, so that the position of the rolling element or rolling elements can be coded by way of the depth variations.

The shape of the depth variation, such as its cross-section, can vary.

At least one of the depth variations can be in the form of a recess. Such a recess can have a circular cross-section. However, other shapes too, such a triangular, square, polygonal, star-shaped or irregular cross-sections of the recesses are also possible. Preferably, several of the depth variations and in particular all the depth variations on a rolling element are in the form of recesses. In particular, all the depth variations on all of the rolling elements can be in the form of recesses.

Recesses can be produced in a simple manner on the lateral surfaces of rolling elements, for example by drilling, milling, etching and the like. The rolling element can also be produced in the intended shape, for example by casting, without having to produce the recess in a final machining process. In the part of the lateral surface having the recesses, the rolling elements can be inserted through an inner race and/or an outer race without the recess scratching or distorting the inner and/or outer race.

At least one, in particular several, or even all the depth variations can be formed by a material surplus. Such surplus material can be added to the rolling element by brazing and/or welding. The material surplus can also be formed on the lateral surface of the rolling element during the production of the rolling element. The formation of the depth variation in the form of surplus material allows the depth variation on the lateral surface of the rolling element to be produced without weakening the rolling element by removing material from it.

The sensor can be attached to the inner race of the roller bearing, to the outer race of the roller bearing, to a cage of the roller bearing, to a housing of the transmission or to a shaft of the transmission.

By attaching the sensor to the inner and/or outer race, in a simple manner the sensor can be arranged in a fixed position relative to the inner and/or outer race. In this way slip of the rolling elements can be detected for several rolling elements if several of them have one or more depth variations, since as a rule the rolling elements move relative to the inner and/or outer race so that several rolling elements can be detected at intervals by a single sensor attached to the inner and/or outer race.

By attaching the sensor to the roller bearing cage, in particular the slip of a rolling element can be detected since the rotational axis of the rolling element is arranged fixed relative to the cage. This allows the slip of a single rolling element to be determined without having to take account of movement of the rotational axis relative to the sensor. This further facilitates the calculation of the rolling element slip.

The sensor can also be attached to the transmission housing or to a transmission shaft. Since the transmission housing is static, it is particularly suitable for the attachment of components because no dynamic properties of the housing have to be taken into account for the fixing. The arrangement of the sensor on a shaft can also be advantageous, since such shafts are usually positioned close to the bearing and therefore to the rolling elements and, especially in wind power machines, they have masses that are large in relation to the mass of the sensor so that the attachment of the sensor to a shaft has no, or only a slight influence on the dynamic properties of the shaft.

In particular the sensor can be a distance sensor, especially an eddy current sensor, an inductive proximity sensor, a Hall sensor or a gearwheel sensor. Such sensors are suitable for detecting the depth variations on the surface of a rolling element within the detection range of the sensor. The measurement of speed and the orientation of the rolling element with reference to a depth variation signal makes it possible to do without sensitive and/or troublesome measurements.

Preferably, the one or more rolling elements, or indeed all the rolling elements are spherical, conical, or they are radial rolling elements or toroidal rolling elements. Such rolling elements are particularly suitable for use in a transmission for a wind power machine.

Preferably, the rolling element has at least one rolling surface and at least one lateral surface with at least one depth variation, such that along a circular line around the rotational axis of the rolling element the latter has at least two different depths.

The objective can also be achieved by a method for determining the speed, the rotational speed and/or the slip of at least one rolling element of a roller bearing, wherein at least one rolling element has different depths along a circular path around its rotational axis and a sensor is arranged on part of the roller bearing in such manner that it can detect the depth variation, whereby from the sensor signal, in particular the time intervals between sensor signals, which depend on the movement of the depth variations past the sensor, the speed, the rotational speed and/or the slip can be calculated.

### BRIEF DESCRIPTION OF THE DRAWINGS

Below, the invention is explained in more detail with reference to an example embodiment and with the help of the drawings, which show:

FIG. 1: Various types of slip,

FIG. 2: A roller bearing arrangement,

FIG. 3: Part of a roller bearing,

FIGS. 4a, 4b, 4c: Various depth variations,

FIGS. 5a, 5b: Various depth variations, formed on a lateral surface of the rolling elements of a bearing,

FIGS. 6a, 6b, 6c: The position of the sensor,

FIGS. 7 to 10: Parts of a roller bearing and the position of the sensor,

FIGS. 11a1-11a4: The computed path of a sensor attached to the outer race of the roller bearing for various degrees of slip,

FIGS. 11b1-11b4: Time variation of the resulting sensor signal,

FIGS. 11c1-11c4: Time interval between various pulses with estimated parabolas,

FIGS. 12a, 12b: Monte Carlo simulation for a rolling element with 20 depth variations and various degrees of slip,

FIGS. 13a, 13b: Monte Carlo simulation for a rolling element with 20 depth variations,

FIGS. 14a, 14b: Test results for a rolling element of diameter 58 mm and 20 depth variations,

FIGS. 15a, 15b: Test results for a rolling element of diameter 58 mm and 20 depth variations, for various types of slip.

### DETAILED DESCRIPTION OF THE PREFERRED EMBODIMENTS

The term “comprises/comprise” should not be interpreted to imply any form of limitation of the invention. The term “comprises/comprise” as used in the claims should not be restricted to the means described therein; it does not exclude other elements, components or steps.

Likewise, where the term “connected/linked” is used in the claims and the description, it should not be interpreted as being limited to direct connections unless expressly so stated. Consequently, the expression “Part A is connected to part B” is not limited to a direct contact of part A with part B, but rather, it also includes indirect contact between parts A and B; in other words, it also includes the case when intermediate components are present between part A and part B.

Not all the embodiments of the invention contain all the features thereof. In the following description and the claims, any of the claimed embodiments can be used in any combination.

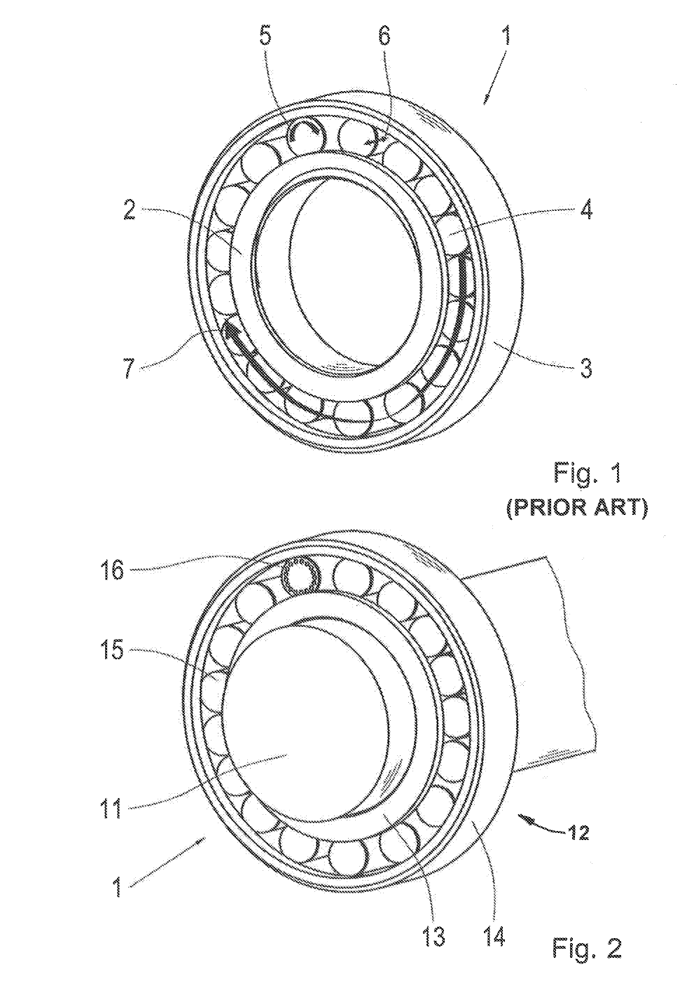

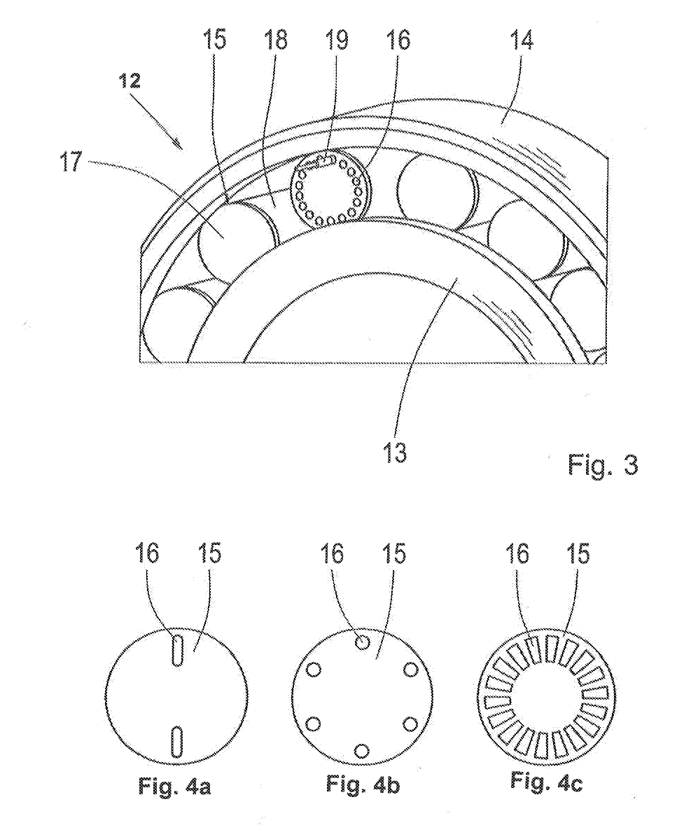

FIG. 2 schematically illustrates a shaft-bearing arrangement 10. The shaft-bearing arrangement 10 comprises a shaft 11 mounted through at least one bearing 12. The shaft 11 can for example be a planetary shaft, a transmission shaft, a pinion shaft or a hollow shaft. In particular, the shaft 11 can be a shaft in a wind power machine. The bearing 12, of which a detail is shown in FIG. 3, comprises an inner ring race 13, an outer ring race 14 and rolling elements 15 between the inner race 13 and the outer race 14. In particular, the outer race 14 of the bearing 12 can be integrated in part of the transmission such as in a planetary wheel of the transmission. The bearing 12 can be a roller bearing with cylindrical rolling elements 15, conical rolling elements 15, radial rolling elements 15 or toroidal rolling elements 15. The bearing 12 can be a radial bearing or an axial bearing.

In one embodiment at least one of the rolling elements 15 of the bearing 12 has at least one depth variation 16. In the example, one of the rolling elements 15 has a plurality of depth variations 16, which are arranged around the rolling element 15 at a distance apart from one another. The rolling elements 15 have two lateral surfaces 17 and one rolling surface 18, and the depth variations 16 are arranged on at least one of the lateral surfaces 17. The depth variations can be on one lateral surface 17 of the rolling element 15, on both lateral surfaces 17 of the rolling element 15, and/or on the rolling surface 18 of the rolling element 15.

In particular, a plurality of rolling elements 15 can have depth variations 16, in particular two depth variations. In other embodiments several rolling elements 15 can be provided with depth variations 16 and the number of depth variations 16 present on the plurality of rolling elements 15 can be equal on each rolling element 15 or different on at least one rolling element 15. In embodiments of the invention any arbitrary number of depth variations 16 can be formed on at least one lateral surface 17 of the rolling element 15. Furthermore, the depth variations can have a suitable shape. Some examples are illustrated in FIGS. 4a, 4b and 4c. These examples are shown only for clarification and not to restrict the invention. For example the depth variations 16 can have, among others, an oval, circular or essentially trapezium-like shape.

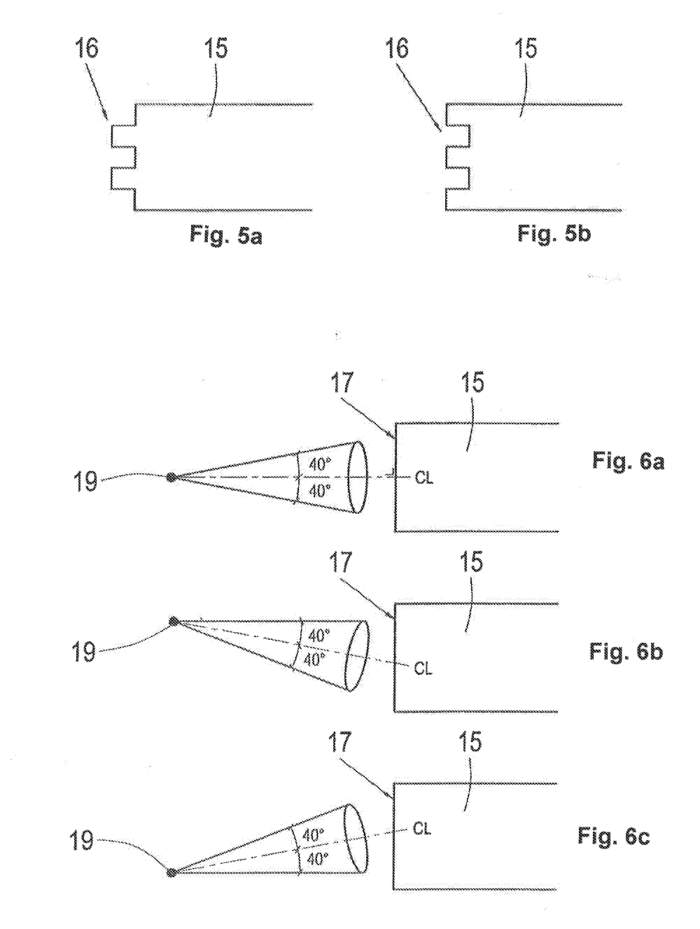

As shown in FIGS. 4a, 4b and 4c, for example two, four or eighteen depth variations 16 can be present. There can also be other, different or odd numbers of depth variations 16. Although in the example illustrated the depth variations 16 are arranged equally spaced around the rolling element 15, the distances between neighboring depth variations 16 can be different. The depth variations 16 can be formed by adding material locally to the rolling element 15 (see FIG. 5a), or in other words producing local protrusions on the at least one rolling element 15. The depth variations 16 could also be formed by removing material locally from the rolling element 15 (see FIG. 5b), or in other words forming grooves locally in the at least one rolling element 15. The format of the depth variations 16 can depend on the type of sensor used. Moreover, the shaft-bearing arrangement 10 comprises at least one sensor 19 for producing a signal when the depth variations 16 move past across it. The sensor 19 is attached fixed to a transmission component of which the shaft-bearing arrangement 10 forms part, or to a component of the roller bearing 12. The sensor has a specified or sensing direction delimited by a cone whose half-angle at the tip is 40°, and a centerline CL of the cone is perpendicular to a plane formed by the lateral surface 17 (FIG. 6a) with a tolerance of +40° or −40° (FIGS. 6b and 6c), which contains the depth variations 16. The centerline CL of the cone is essentially perpendicular to the plane formed by the lateral surface 17 containing the depth variations 16.

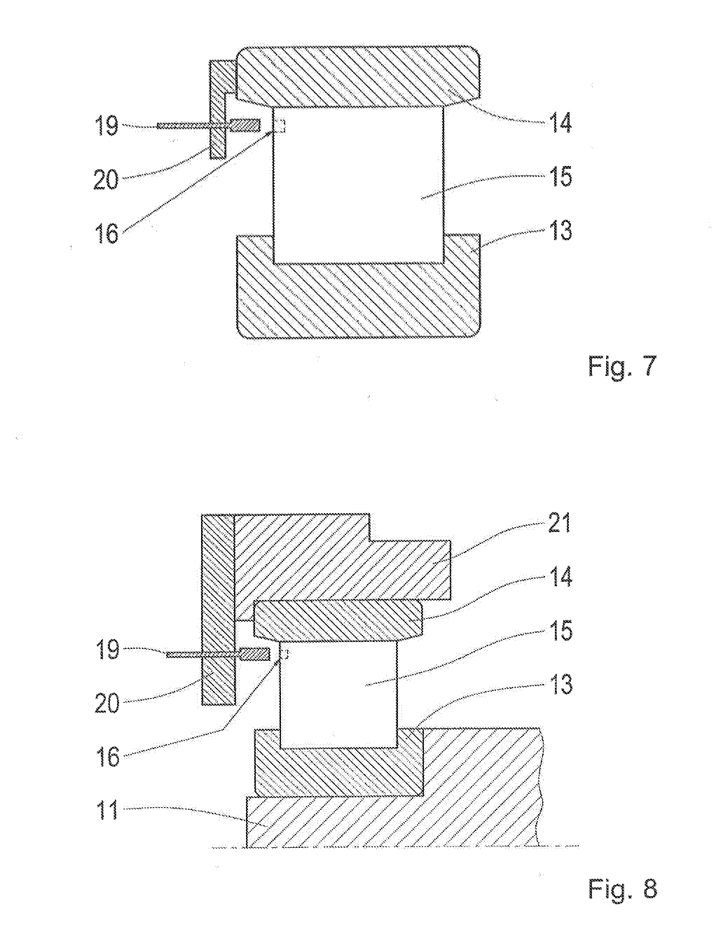

In an embodiment of the invention the sensor 19 can be connected fixed to a component of the roller bearing 12 by means of a connecting piece 20. For example, with the help of the connecting piece 20 the sensor 19 can be attached fixed to the outer race 14 of the roller bearing 12. This is illustrated in FIG. 7. In a similar manner the sensor 19 can be attached fixed to an inner race 13 of the roller bearing 12 or to a cage of the roller bearing 12 (this is not shown in the figures). In other embodiments the sensor 19 can be attached fixed to part of the transmission. For example, by means of the connecting piece 20 the sensor 19 can be attached fixed to the transmission housing 21 (see FIG. 8) or, in a similar manner, to a shaft 11 of the transmission (this is not shown in the figures). The connecting piece 20 between the transmission component and the sensor 19 can be formed by a separate connecting piece 20, as shown in FIG. 8, or by a connecting piece 20 formed integrally with the transmission component and connected to the sensor 19 (not shown in the figures).

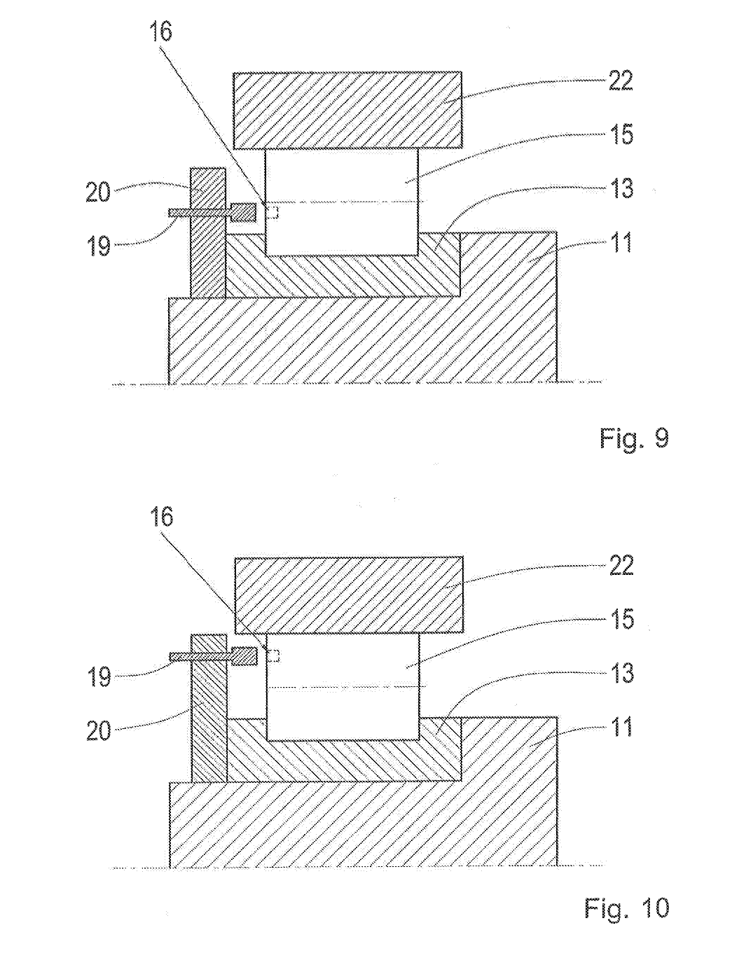

In an embodiment the shaft 11 can be a planetary shaft 11 and the bearing 12 can serve to mount planetary gearwheels 22 on the planetary shaft 11, or in other words it can be a planetary gearwheel bearing 12. In accordance with this special example the outer race 14 of the bearing 12 can be incorporated in the planetary gearwheel 22 and the sensor 19 can be connected fixed to the inner race 13 of the bearing 12 by way of the connecting piece 20. This is illustrated in FIGS. 9 and 10. The difference between the two figures is the position of the sensor 19. In principle the sensor 19 can be positioned anywhere relative to the rolling element 15, but the farther away the sensor 19 is from the centerline of the rolling element 15 (indicated by a broken line), the better the sensor signal will be. The sensor 19 can be any type of sensor familiar to those with knowledge of the subject which is suitable for the detection of depth variations. According to embodiments of the invention the sensor 19 can be a distance sensor such as an eddy current sensor, or it can be a pulse emitter such as an inductive proximity switch sensor, a Hall sensor or a gearwheel sensor. These sensors have the advantage that they can detect the presence of nearby iron-containing objects without direct physical contact.

In an embodiment of the invention the sensor 19 can detect the speed of the rolling element 15 regardless of which of the bearing races 13 or 14 is rotating.

By virtue of appropriate positioning and careful choice of the sensor 19, it is possible to determine three types of slip in one step or with the same sensor signal, namely rolling element slip, cage slip and axial slip. For example, if the sensor 19 is attached to the inner race 13 or the outer race 14 of the bearing 12, the rotational speed can be determined at the instant when the sensor moves past the rolling element 15. An advantage of this sensor positioning is that the rotational speed of the cage of the bearing 12 can also be determined; in that way, the cage slip can also be calculated from the sensor signal. For example, if an eddy current sensor 19 is being used, which can measure the axial displacement of the rolling element 15, then from only a single sensor signal three types of slip can be determined, namely rolling element slip, cage slip and axial slip.

The present invention also envisages the use of a bearing as described above with reference to various embodiments in order to determine the speed of at least one rolling element 15 in the bearing 12 or to determine the slip in the bearing 12.

Below, it is explained how to determine the slip or the speed of at least one of the rolling elements 15 in embodiments of the invention.

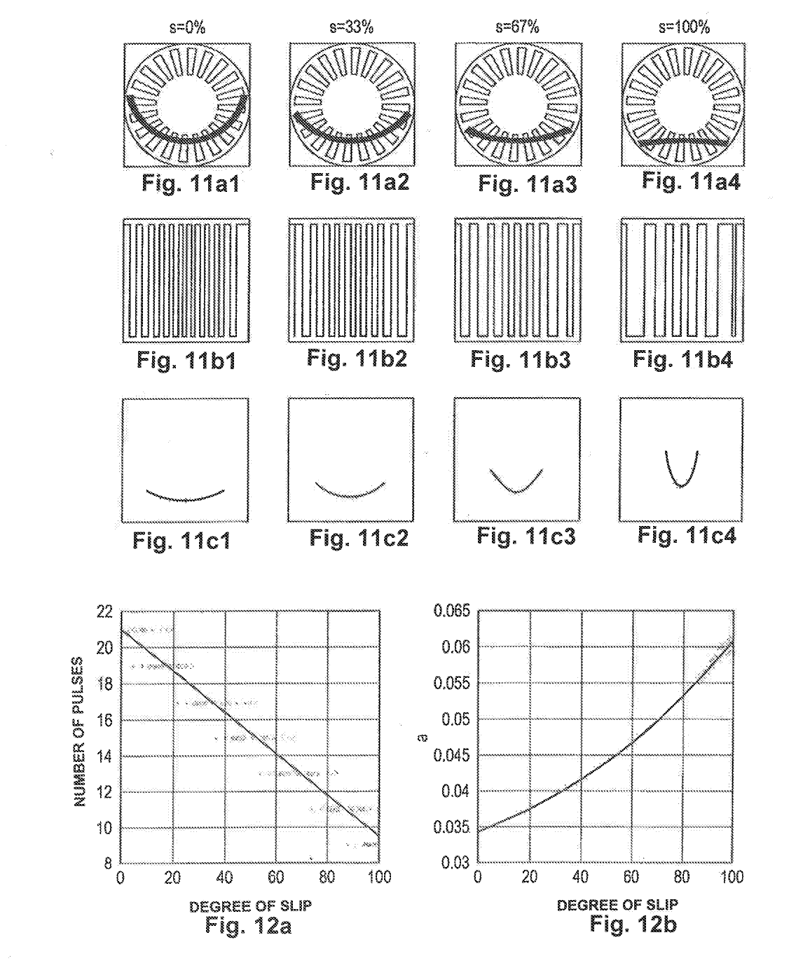

As an example, FIGS. 11a1-11c4 show Matlab simulations for roller bearings 12 with a rotating inner race 13 and a stationary outer race 14, wherein the sensor 19 is attached to the outer race 14. The invention is also applicable to bearings in which the inner race 13 is fixed and the outer race 14 rotates. The rolling element 15 for which the measurements are simulated has 20 depth variations 16 arranged spaced apart from one another around the rolling element 15. FIGS. 11a1, 11a2 and 11a3 show the computed track of the sensor 19 in the co-ordinate system of the rolling element 15 for various degrees of slip. The bold black line in the figures indicates the path followed by the sensor 19. FIGS. 11a1, 11a2, 11a3 and 11a4 respectfully illustrate slips of 0%, 33%, 67% and 100%. In this context a slip of 0% is understood to mean that the path covered by the rolling element relative to the inner race contains no fraction that is attributed to slip. For a slip of 10%, the fraction of the path attributable to slip movement in relation to the total path of the rolling element relative to the inner race is equal to 0.1. The other percentages signify the corresponding values. From the figure it emerges that depending on the degree of slip, different numbers of depth variations 16 will move past the sensor 19. That is also clear from the time signals of the sensors pictured in FIGS. 11b1-11b4. This means that the degree of slip can be determined since whenever the rolling element 15 with the depth variations 16 moves past the sensor 19, the number of pulses is counted. The measurement resolution can be increased by not only counting the number of pulses in the sensor signal, but also taking the time interval between the pulses into account. The shape of the vector-time lengths is a parabola (see FIG. 11c1-11c4). The estimated parameters of the parabola serve for an evaluation of the degree of slip.

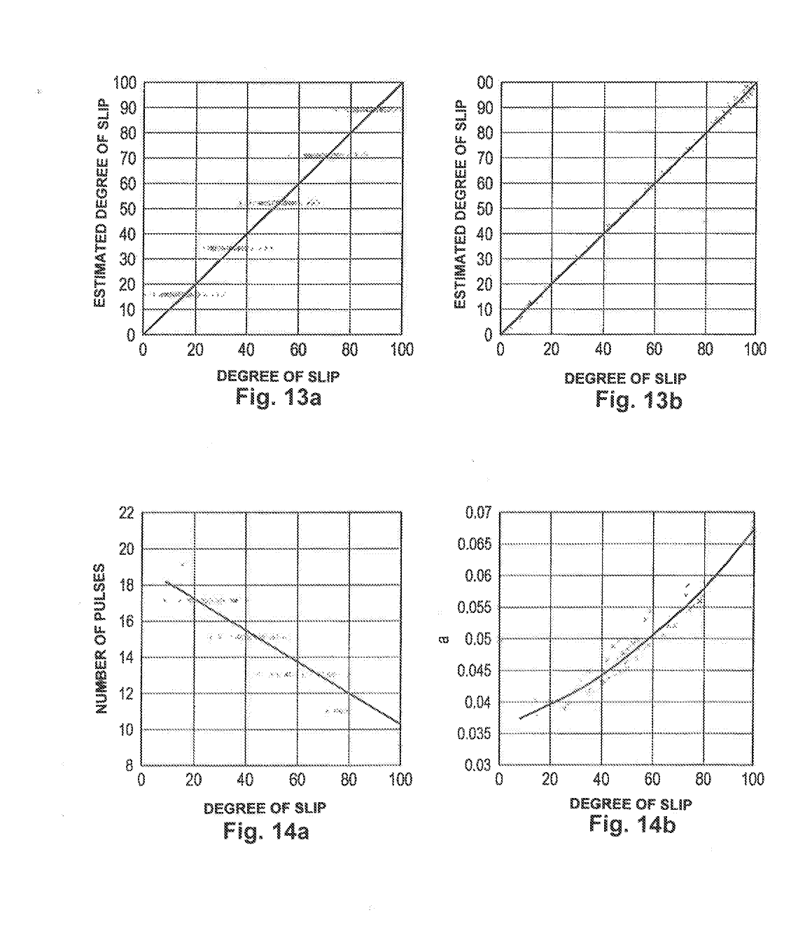

FIGS. 12a and 12b show results of simulations for a rolling element 15 as described above for FIGS. 11a1-11c4, with a random initial angle of the rolling element 15 at the instant when the rolling element 15 moves past the sensor 19. FIG. 12a shows the number of pulses counted each time the sensor 19 moves past the rolling element 15. FIG. 12b shows the parameter a of the parabola with equation y=a+bx², calculated from the variation of the time intervals between the pulses plotted against the time. Then, from these simulations a function of the pulse number and the parameter a is determined as a function of the slip. That function is represented in FIGS. 12a and 12b by the bold continuous line. In FIG. 12a this is a straight line while in FIG. 12b an approximation of the second order is used. With reference to these functions the degree of slip for the simulations is then estimated. The results are shown in FIGS. 13a and 13b. The degree of slip estimated from the number of pulses detected in the signal is shown in FIG. 13a. From that diagram it emerges that 95% of the estimated values lie within a variation of 15% from the actual degree of slip, i.e. for 95% of the crosses in the diagram, the difference from the actual degree of slip (straight line) is smaller than 15%. If the function is used for parameter a of the estimated parabola, an error of only 2% is obtained (see diagram on the right).

The simulations were checked experimentally. To validate the simulations a first test arrangement was set up. A rolling element 15 with a diameter of 58 mm was provided with 20 depth variations 16 produced a distance apart around the rolling element 15, and this was driven by an electric motor in order to obtain the rolling element speed. In the test a gearwheel sensor was used, which was attached to a pendulum. The swinging speed of the pendulum was measured with an incremental emitter and represents the cage speed of the bearing.

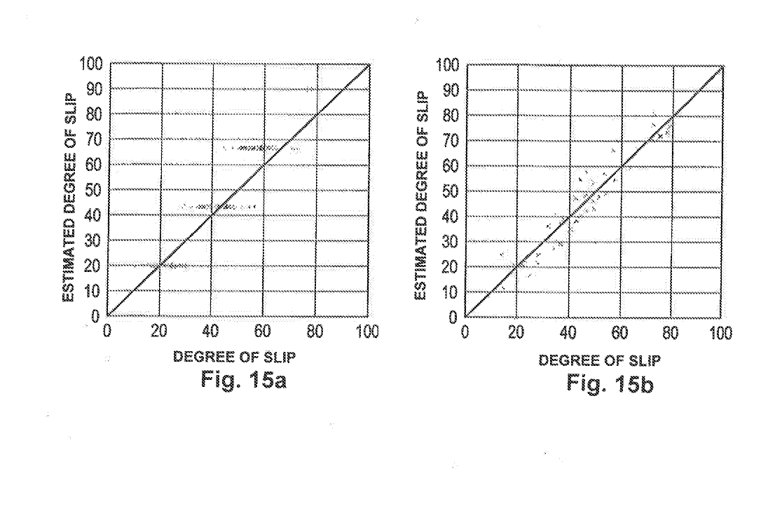

Each time the sensor moved past the turning rotating element the number of pulses and the time interval between the individual pulses were recorded. In a manner similar to that described above for the simulation, from the sensor signal the rolling slip was estimated. This estimate was compared with an accurately determined slip value, the latter calculated from values of the measured pendulum speed (=cage speed) and the motor speed (rolling element speed). The results are shown in FIGS. 14a, 14b and 15a, 15b. In the case of the degree of slip estimated from the number of pulses detected in the signal, 95% of the estimated values lie within a variation of 17% from the actual degree of slip; this is comparable to the simulation result. If the function for parameter a of the estimated parabola is used, an error of 9% is obtained.

1-12. (canceled)

13. A roller bearing (10) for a transmission, the roller bearing (10) comprises:
an inner bearing race (13),
an outer bearing race (14),
at least one rolling element (15), and
a sensor (19) arranged fixed relative to either a transmission component or a part of the roller bearing (10), and the at least one rolling element (15) has at least one depth variation (16) on at least one lateral surface (17) thereof, the depth variation being designed such that along a circular path around a rotational axis of the rolling element (15), the lateral surface of the rolling element (15) has at least two different depths and the sensor being positioned so as to detect the depth variation.

14. The roller bearing (10) for a transmission according to claim 13, wherein a plurality of rolling elements (15) of the roller bearing (10) have depth variations (16).

15. The roller bearing (10) according to claim 13, wherein the at least one rolling element (15) has a plurality of depth variations (16).

16. The roller bearing (10) according to claim 13, wherein the at least one depth variation (16) is a recess.

17. The roller bearing (10) according to claim 13, wherein the at least one depth variation (16) is surplus material.

18. The roller bearing (10) according to claim 13, wherein the sensor (19) is attached to one of:
the inner bearing race (13) of the roller bearing (10);
the outer bearing race (14) of the roller bearing (10);
a cage of the roller bearing (10);
a housing of the transmission; and
a shaft (11) of the transmission.

19. The roller bearing (10) according to claim 13, wherein the sensor (19) is one of a distance sensor, an eddy current sensor, an inductive proximity sensor, a Hall sensor, and a gearwheel sensor.

20. The roller bearing (10) according to claim 13, wherein the roller bearing (10) comprises one of cylindrical rolling elements, conical rolling elements, radial rolling elements, and toroidal rolling elements.

21. A rolling element (15) for the roller bearing (10) for a transmission according to claim 13, wherein the transmission is for a wind power machine, the rolling element (15) comprises a rolling surface and at least one lateral surface, the at least one lateral surface has a depth variation such that along a circular path around a rotational axis of the rolling element (15), the rolling element (15) has at least two different depths.

22. A method of determining at least one of a speed, a rotational speed and a slip of at least one rolling element (15) of a roller bearing (10), the method comprising:
providing a lateral surface of the at least one rolling element (15) with depth variations along a circular path around a rotational axis of the at least one rolling element (15);
attaching a sensor (19) on a part of the roller bearing (10);
detecting, with the sensor, the depth variations of the lateral surface of the at least one rolling element; and
calculating at least one of the speed, the rotational speed and the slip of at least one rolling element from time intervals of sensor signals, based on movement of the depth variations past the sensor.

23. A transmission in combination with a roller bearing (10) comprising:
an inner bearing race (13),
an outer bearing race (14),
at least one rolling element (15), and
a sensor (19) arranged fixed relative to either a transmission component or a part of the roller bearing (10), and the at least one rolling element (15) has at least one depth variation (16) on at least one lateral surface (17) thereof, the depth variation being designed such that along a circular path around a rotational axis of the rolling element (15), the lateral surface of the rolling element (15) has at least two different depths and the sensor being positioned so as to detect the depth variation.

24. Use of at least one of a rolling element according to claim 21, wherein the rolling element is used in a transmission for a wind power machine.
